(19) United States
(12) Patent Application Publication
(10) Pub. No.: US 2025/0309290 A1
(43) Pub. Date: Oct. 2, 2025

(54) ELECTROCHEMICAL HYDROGEN COMPRESSION SYSTEM

(71) Applicant: HONDA MOTOR CO., LTD., TOKYO (JP)

(72) Inventor: Yuta HOSHI, WAKO-SHI (JP)

(21) Appl. No.: 19/066,990

(22) Filed: Feb. 28, 2025

(30) Foreign Application Priority Data
Mar. 28, 2024 (JP) 2024-053997
Jul. 18, 2024 (JP) 2024-114965

(51) Int. Cl. H01M 8/04089; H01M 4/86

(52) U.S. Cl. CPC H01M 8/04089; H01M 4/86; H01M 2004/8684; H01M 2004/8694

(57) ABSTRACT

An electrochemical hydrogen compression system comprises a hydrogen compression stack having a unit cell including an electrolyte membrane, an anode disposed on one surface of the electrolyte membrane, and a cathode disposed on another surface of the electrolyte membrane, and that supplies a hydrogen gas to the anode, and delivers from the cathode the hydrogen gas which has been compressed, an electrical power source device that applies a voltage to the hydrogen compression stack, a hydrogen supply device that supplies the hydrogen gas to the hydrogen compression stack, a storage device that stores the hydrogen gas output from the hydrogen compression stack, and a return flow path that returns the hydrogen gas output from the hydrogen compression stack to the hydrogen supply device, wherein a hydrogen storage tank that stores the hydrogen gas is provided in the return flow path.

### CROSS-REFERENCE TO RELATED APPLICATIONS

This application is based upon and claims the benefit of priority from Japanese Patent Applications No. 2024-053997 filed on Mar. 28, 2024 and No. 2024-114965 filed on Jul. 18, 2024, the contents all of which are incorporated herein by reference.

### BACKGROUND OF THE INVENTION

### Field of the Invention

The present disclosure relates to an electrochemical hydrogen compression system.

### Description of the Related Art

In recent years, in order to make it possible for more people to be capable of relying thereon at an affordable cost, and to ensure access to sustainable and advanced energy, research and development have been conducted in relation to an electrochemical hydrogen compression system that contributes to energy efficiency.

In JP 2022-083098 A, a control method for a hydrogen/oxygen production system, and a hydrogen/oxygen production system are disclosed. Such a hydrogen/oxygen production system is equipped with a water electrolysis device that electrolyzes liquid water by passing an electrical current between an anode and a cathode, and a hydrogen gas compression unit (hydrogen compression stack) located more downstream than the water electrolysis device, and which compresses the hydrogen by passing an electrical current between an anode of the compression unit and a cathode of the compression unit. In addition, at a time when the hydrogen/oxygen production system is stopped, a first pressure reducing process is carried out in a manner so that a pressure reducing speed of the cathode of the compression unit of the hydrogen compression stack does not exceed a basic pressure reducing speed, and together therewith, a second pressure reducing process is carried out in a manner so that the pressure reducing speed of the anode of the water electrolysis device does not exceed a pressure reducing speed rate of the cathode of the compression unit. In accordance with this feature, it is possible to suppress a condition in which the pressure at the cathode of the compression unit is suddenly reduced, and to suppress damage from occurring to the electrolyte membrane of the hydrogen gas compression unit.

### SUMMARY OF THE INVENTION

Incidentally, in the hydrogen compression stack, at a time when the hydrogen compression stack is stopped, hydrogen gas remains on the side of the cathode. Since the pressure of this hydrogen gas is not sufficiently high, a process has been carried out in which the hydrogen gas is released into the atmosphere. Upon doing so, this hydrogen gas is not used effectively, which has brought about a problem in that the hydrogen production efficiency of the electrochemical hydrogen compression system decreases.

The present invention has the object of solving the aforementioned problem.

An aspect of the present disclosure is characterized by an electrochemical hydrogen compression system, comprising a hydrogen compression stack having a unit cell including an electrolyte membrane, an anode disposed on one surface of the electrolyte membrane, and a cathode disposed on another surface of the electrolyte membrane, and configured to supply a hydrogen gas to the anode, and to deliver from the cathode the hydrogen gas which has been compressed, an electrical power source device configured to apply a voltage to the hydrogen compression stack, a hydrogen supply device configured to supply the hydrogen gas to the hydrogen compression stack, a storage device configured to store the hydrogen gas output from the hydrogen compression stack, and a return flow path configured to return the hydrogen gas output from the hydrogen compression stack to the hydrogen supply device, wherein a hydrogen storage tank configured to store the hydrogen gas is provided in the return flow path.

According to the above-described aspect, the hydrogen gas, by way of the return flow path, is returned to the hydrogen supply device, and in addition, since the hydrogen gas is stored in the hydrogen storage tank provided in the return flow path, from among the hydrogen gas remaining on the side of the cathode, the amount of the hydrogen gas that is released to the exterior at the time when the hydrogen compression stack is stopped is reduced. Accordingly, it is possible to suppress a decrease in the hydrogen production efficiency of the electrochemical hydrogen compression system.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic configuration diagram of an electrochemical hydrogen compression system according to a first embodiment;

FIG. 2 is a flow chart according to the first embodiment;

FIG. 3 is an explanatory diagram in relation to a change in the pressure of the hydrogen gas in accordance with the first embodiment;

FIG. 4 is a schematic configuration diagram of an electrochemical hydrogen compression system according to a second embodiment;

FIG. 5 is a flow chart according to the second embodiment; and

FIG. 6 is an explanatory diagram in relation to a change in the pressure of the hydrogen gas in accordance with the second embodiment.

### DETAILED DESCRIPTION OF THE INVENTION

### First Embodiment

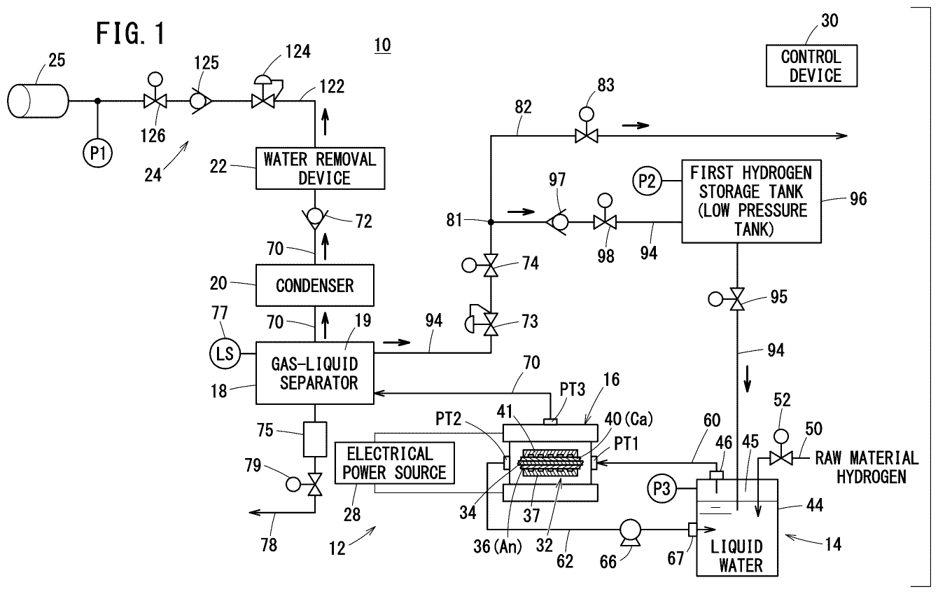

FIG. 1 is a schematic configuration diagram of an electrochemical hydrogen compression system 10 according to a first embodiment. The electrochemical hydrogen compression system 10 comprises an electrochemical hydrogen compression device 12, a hydrogen supply device 14, a gas-liquid separator 18, a condenser 20, a water removal device 22, a first hydrogen storage tank 96, a storage device 24, and a control device 30.

The electrochemical hydrogen compression device 12 is a device that electrochemically compresses a hydrogen gas. The electrochemical hydrogen compression device 12 is equipped with a hydrogen compression stack 16, and an electrical power source device 28 that applies a voltage to the hydrogen compression stack 16.

The hydrogen compression stack 16 supplies the hydrogen gas to an anode 36, and delivers the hydrogen gas (high pressure hydrogen gas) that has been compressed from a cathode 40. The pressure of the hydrogen gas, which was compressed at the cathode 40, is higher than the pressure of the hydrogen gas supplied to the anode 36.

The hydrogen compression stack 16 includes a hydrogen inlet PT1, a hydrogen outlet PT2, and a high pressure hydrogen outlet PT3. The hydrogen inlet PT1 introduces the hydrogen gas supplied from the hydrogen supply device 14 into the hydrogen compression stack 16. The introduced hydrogen gas communicates with the anode 36 of each of the unit cells 32. The hydrogen outlet PT2 discharges the unused hydrogen gas. The high pressure hydrogen outlet PT3 outputs high pressure hydrogen gas (hydrogen gas of a high pressure) that is generated in each of the unit cells 32. The high pressure hydrogen gas communicates with the cathode 40 of each of the unit cells 32.

The hydrogen compression stack 16 is constituted by stacking a plurality of the unit cells 32. All of the plurality of unit cells 32 have the same structure. Each of the unit cells 32 includes an electrolyte membrane 34, the anode 36 provided on one surface of the electrolyte membrane 34, an anode current collector 37, the cathode 40 provided on another surface of the electrolyte membrane 34, and a cathode current collector 41.

As the electrolyte membrane 34, there is employed, for example, a solid polymer electrolyte membrane (cation exchange membrane). The electrolyte membrane 34 may be reinforced on the anode side thereof with a protective sheet (not shown) containing a fibrous skeletal framework. In accordance with this feature, it is possible to withstand the pressure of the high pressure hydrogen gas applied from the side of the cathode. Further, the electrolyte membrane 34 can make use of a fluorine-based electrolyte. The electrolyte membrane 34 may be an HC (hydrocarbon) based electrolyte. The electrolyte membrane 34 is sandwiched between the anode 36 and the cathode 40.

The anode 36 includes an anode catalyst layer bonded to the one surface of the electrolyte membrane 34. The anode current collector 37 is stacked on the anode catalyst layer. The anode catalyst layer includes a platinum-based catalyst. An anode flow path through which hydrogen gas flows is formed in the anode current collector 37. Moreover, the anode current collector 37 may be a conductive porous plate. The hydrogen gas introduced from the hydrogen inlet PT1 flows through the anode flow path and arrives at the anode catalyst layer. A porous reinforcing plate may be interposed between the anode catalyst layer and the anode current collector 37. The reinforcing plate is capable of effectively withstanding the pressure of the high pressure hydrogen gas that is applied from the side of the cathode.

The cathode 40 includes a cathode catalyst layer bonded to the other surface of the electrolyte membrane 34. The cathode current collector 41 is stacked on the cathode catalyst layer. The cathode catalyst layer includes a platinum-based catalyst. A cathode flow path through which pressurized high pressure hydrogen gas flows is formed in the cathode current collector 41. Moreover, the cathode current collector 41 may be a conductive porous plate. The high pressure hydrogen gas generated at the cathode 40 flows through the cathode flow path and is output from a high pressure hydrogen outlet PT3.

When a voltage is applied from the electrical power source device 28 between the anode 36 and the cathode 40, the hydrogen gas supplied from the hydrogen inlet PT1 to the anode 36 is ionized into protons (hydrogen ions) and electrons by a catalytic reaction in the anode catalyst layer. The generated protons permeate through the electrolyte membrane 34 and move to the cathode 40. At this time, the protons accompany water to the cathode 40. Accordingly, the hydrogen gas that is supplied from the hydrogen supply device 14 to the anode 36 is humidified and contains water. At the cathode 40, the protons that have permeated through the electrolyte membrane 34 combine with the electrons, and thereby generate the high pressure hydrogen gas by way of an electrochemical reaction. Unused hydrogen gas that has not been ionized at the anode 36 is discharged from the hydrogen outlet PT2. The pressure of the high pressure hydrogen gas that flows through the cathode flow path is higher than the pressure of the hydrogen gas that flows through the anode flow path.

The electrical power source device 28 applies a DC voltage to the hydrogen compression stack 16. In accordance therewith, the electrical current flows to the hydrogen compression stack 16. The hydrogen compression stack 16 includes a stacked body in which a plurality of the unit cells 32 are stacked, and an anode connection terminal and a cathode connection terminal disposed respectively on both ends of the stack. A positive electrode of the electrical power source device 28 is connected via a connection cable to the anode connection terminal, and a negative electrode of the electrical power source device 28 is connected via a connection cable to the cathode connection terminal. In accordance with this feature, a positive voltage is applied via the anode current collector 37 to the anode 36 of each of the unit cells 32, and a negative voltage is applied via the cathode current collector 41 to the cathode 40 of each of the unit cells 32.

The electrical power source device 28, in response to a control command from the control device 30, is capable of adjusting the size of the voltage applied to the hydrogen compression stack 16. The voltage applied to the hydrogen compression stack 16 is applied equally to each of the unit cells 32. As the voltage supplied to the hydrogen compression stack 16 becomes greater, the greater becomes the current that flows from the anode 36 to the cathode 40, and the greater becomes the amount of the high pressure hydrogen gas that is generated in the hydrogen compression stack 16.

The hydrogen supply device 14 includes a sealed container 44 in which the liquid water is stored downwardly in the direction of gravity. The raw material hydrogen is supplied via a raw material hydrogen supply path 50 into the liquid water of the sealed container 44. An opening/closing valve 52 is provided in the raw material hydrogen supply path 50. The opening/closing valve 52 causes the raw material hydrogen to flow by being opened, and stops the flow of the raw material hydrogen by being closed.

The raw material hydrogen includes a predetermined gas pressure, and such a gas pressure is the pressure of the raw material hydrogen.

The raw material hydrogen supply path 50 extends in the direction of gravity inside the sealed container 44, and has an opening on an end thereof on a downstream side. Such an opening opens within the liquid water of the sealed container 44, and the raw material hydrogen flows out from the opening as hydrogen gas, turns into gas bubbles (undergoes bubbling) inside the liquid water, and rises upwardly of the sealed container 44. At this time, the liquid droplets contained in the raw material hydrogen are taken into the liquid water. Further, the hydrogen gas that has risen upwardly of the liquid water is humidified by the liquid water. The sealed container 44 includes both a function as a gas-liquid separator and a function as a humidifier.

The raw material hydrogen may contain hydrogen gas, and may be generated, for example, by the electrolysis of water. Alternatively, the raw material hydrogen may be generated by a reforming reaction from a raw material containing hydrocarbons. The raw material hydrogen may contain conductive components therein such as potassium hydroxide contained in the electrolyte when the water is subjected to electrolysis, and impurities other than the hydrogen gas that are generated during the reforming reaction. These impurities are removed in the hydrogen compression stack 16, and are not contained within the high pressure hydrogen gas that is generated.

Upwardly of the liquid water that is stored in the sealed container 44, a gas chamber 45 is formed in which there is collected the hydrogen gas that has passed through the liquid water and has been humidified. The hydrogen gas which is contained in the interior of the gas chamber 45 is pressurized to a predetermined pressure. This is because the raw material hydrogen which has been pressurized is supplied. A pressure sensor P3, which communicates with the gas chamber 45, and measures the pressure of the hydrogen gas contained in the gas chamber 45, is provided in the sealed container 44. Further, a hydrogen outlet 46, which communicates with the gas chamber 45 and through which the hydrogen gas is output, is provided upwardly of the sealed container 44. The hydrogen gas that has been pressurized to the predetermined pressure is smoothly output from the hydrogen outlet 46.

The hydrogen outlet 46 communicates via a hydrogen supply flow path 60 with the hydrogen inlet PT1 of the hydrogen compression stack 16. The hydrogen outlet PT2 of the hydrogen compression stack 16 communicates via a hydrogen circulation flow path 62 with a hydrogen circulation inlet 67 of the sealed container 44. The hydrogen circulation inlet 67 communicates with the liquid water of the sealed container 44. The unused hydrogen gas in the hydrogen compression stack 16 is circulated inside the hermetically sealed container 44. A circulation pump 66 for causing the hydrogen gas to be circulated is provided in the hydrogen circulation flow path 62.

The high pressure hydrogen outlet PT3 of the hydrogen compression stack 16 communicates, via a high pressure hydrogen supply flow path 70, with the water removal device 22. In the high pressure hydrogen supply flow path 70, the gas-liquid separator 18, the condenser 20, and a check valve 72 are provided in this order from an upstream side. Moreover, the condenser 20 may be provided in accordance with the specifications required for the high pressure hydrogen gas, and need not necessarily be provided.

The check valve 72, together with causing the high pressure hydrogen gas to flow from the condenser 20 to the water removal device 22, also prevents the high pressure hydrogen gas from flowing back from the water removal device 22 to the condenser 20. In accordance with this feature, without causing the internal pressure of the water removal device 22 to be reduced, it is possible to shorten the time period required for the rise in pressure at the time of a subsequent starting.

The gas-liquid separator 18 separates the high pressure hydrogen gas into a liquid component (liquid droplets) and a gas component, and removes the liquid component as liquid water. In addition, the high pressure hydrogen gas from which the liquid water has been removed is supplied to the water removal device 22 via the condenser 20 provided on a downstream side. The gas-liquid separator 18 is constituted by a sealed container. A level switch 77, which measures the amount of the liquid water that is stored, is provided in the interior of the gas-liquid separator 18. The level switch 77 measures the height of the liquid surface (an upper surface of the liquid water) that is stored in the interior of the gas-liquid separator 18.

A drain flow path 78, which discharges the separated liquid water to the exterior, is connected downwardly of the gas-liquid separator 18 in the direction of gravity. A throttle valve 75 and an opening/closing valve 79 are provided in the drain flow path 78 sequentially in this order from the upstream side. The throttle valve 75 adjusts the flow amount of the liquid water that flows through the drain flow path 78. The opening/closing valve 79, by being opened, discharges the liquid water from the drain flow path 78, and by being closed, stops the discharging of the liquid water. When the control device 30, by means of a signal from the level switch 77, detects that the liquid water that is stored in the interior of the gas-liquid separator 18 exceeds an upper limit value, the opening/closing valve 79 opens, and releases to the exterior the liquid water whose flow amount has been adjusted through the throttle valve 75.

A gas inlet of the gas-liquid separator 18 communicates via the high pressure hydrogen supply flow path 70 with the high pressure hydrogen outlet PT3 of the hydrogen compression stack 16. A gas outlet of the gas-liquid separator 18 communicates with a gas inlet of the condenser 20.

The condenser 20 is provided in the high pressure hydrogen supply flow path 70 between the gas-liquid separator 18 and the water removal device 22. The condenser 20 cools the high pressure hydrogen gas by carrying out heat exchange with the flowing high pressure hydrogen gas. In accordance with this feature, the water vapor contained in the high pressure hydrogen gas is condensed, and thereby causes the humidity of the high pressure hydrogen gas to be reduced. More specifically, the dew point of the high pressure hydrogen gas decreases.

As the water removal device 22, for example, a PSA (Pressure Swing Adsorption) device is used. The PSA device is equipped with a plurality of adsorption towers, each of which is filled with a porous adsorbent such as activated carbon, zeolite, alumina, or silica or the like. The plurality of adsorption towers are alternately switched, and thereby adsorb by means of an adsorbent water contained in the introduced hydrogen gas, and discharge a dried hydrogen gas. When the amount of water adsorbed by the adsorbent has reached an upper limit value, the adsorbed water is released by passing the dried hydrogen gas through the adsorption tower, and the adsorbent is brought back into the reusable condition.

A hydrogen inlet of the water removal device 22 communicates via the high pressure hydrogen supply flow path 70 with the high pressure hydrogen outlet PT3 of the hydrogen compression stack 16. A hydrogen outlet of the water removal device 22 communicates via a high pressure hydrogen outlet flow path 122 with the storage device 24. The storage device 24 includes, for example, a hydrogen tank 25 that stores the high pressure hydrogen gas. The storage device 24 may be any device that is capable of storing the high pressure hydrogen gas, and may be a high pressure container that contains a hydrogen storage alloy therein.

A back pressure valve 124, a check valve 125, and an opening/closing valve 126 are provided in the high pressure hydrogen outlet flow path 122 sequentially in this order from the upstream side. The back pressure valve 124 adjusts the pressure of the high pressure hydrogen gas that is output. The check valve 125, together with causing the high pressure hydrogen gas to flow to the storage device 24 from the water removal device 22, prevents the high pressure hydrogen gas from flowing back from the storage device 24 to the water removal device 22. Accordingly, after the storage device 24 has been filled with the high pressure hydrogen gas, even if the pressure on the upstream side decreases during the depressurization, the gas pressure in the interior of the storage device 24 is maintained.

The opening/closing valve 126 provided in the high pressure hydrogen outlet flow path 122, by being opened, supplies the high pressure hydrogen gas to the storage device 24, and by being closed, stops the supply of the high pressure hydrogen gas to the storage device 24. A dispenser, a coupler, or the like that is capable of releasing the connection of the hydrogen tank 25 may be provided between the high pressure hydrogen outlet flow path 122 and the hydrogen tank 25. The hydrogen tank 25 is installed in a mobile vehicle that is equipped with a fuel cell system, industrial equipment, a stationary electrical power generation equipment, or the like. Moreover, the hydrogen tank 25 may be installed in a device that makes use of hydrogen gas, but which is not equipped with a fuel cell system.

The storage device 24 includes a pressure sensor P1 that measures the pressure of the high pressure hydrogen gas. The pressure sensor P1 is provided, in the high pressure hydrogen outlet flow path 122, in a pipe on a downstream side of the back pressure valve 124. Moreover, the pressure sensor P1 may be provided directly in the interior of the hydrogen tank 25.

A gas chamber 19 through which the high pressure hydrogen gas flows is formed upwardly of the gas-liquid separator 18 in the direction of gravity. The gas chamber 19 communicates with the interior of the sealed container 44 that is equipped with the hydrogen supply device 14 via a return flow path 94. The first hydrogen storage tank 96, which is a hydrogen storage tank, is provided in the return flow path 94. The first hydrogen storage tank 96 includes a gas inlet and a gas outlet. Moreover, the gas inlet and the gas outlet may be integrated together into a single gas flow port. In that case, the gas inlet and the gas outlet may be disposed separately in a pipe that is connected to the gas flow port.

An opening/closing valve 95 is disposed, between the first hydrogen storage tank 96 and the sealed container 44, in the return flow path 94. The opening/closing valve 95 is disposed on a downstream side of the first hydrogen storage tank 96. The opening/closing valve 95, by being opened, supplies the hydrogen gas from the first hydrogen storage tank 96 to the sealed container 44, and by being closed, stops the supply of the hydrogen gas from the first hydrogen storage tank 96 to the sealed container 44.

The return flow path 94 communicates with the gas chamber 19 of the gas-liquid separator 18 through which the high pressure hydrogen gas flows. Accordingly, when the hydrogen compression stack 16 stops operating, since the high pressure hydrogen gas smoothly flows out from the gas chamber 19 to the first hydrogen storage tank 96, and the gas chamber 19 is reduced in pressure, the flow path on the side of the cathode of the hydrogen compression stack 16 that communicates with the gas chamber 19 can be rapidly reduced in pressure.

Moreover, an end on an upstream side of the return flow path 94 may be connected to the high pressure hydrogen supply flow path 70 or the high pressure hydrogen outlet flow path 122. Further, the end on the upstream side of the return flow path 94 may be connected to the condenser 20 or the water removal device 22. The first hydrogen storage tank 96 is constituted as the sealed container. The shape of the sealed container is not particularly limited. The first hydrogen storage tank 96 is formed, for example, in the shape of a cylinder, a sphere, a rectangular parallelepiped, or the like. A pressure sensor P2 that measures the pressure of the stored hydrogen gas is provided in the first hydrogen storage tank 96. The pressure sensor P2 may be disposed in a pipe connected to a gas inlet or a gas outlet provided in the first hydrogen storage tank 96.

The end on the downstream side of the return flow path 94 includes a hydrogen release hole. The hydrogen release hole opens into the gas chamber 45 on an upper part of the sealed container 44. Moreover, as shown in FIG. 1, the hydrogen release hole may open into the liquid water of the sealed container 44. In accordance with this feature, water droplets is removed from the hydrogen gas that is released from the hydrogen release hole within the liquid water, and the hydrogen gas is satisfactorily humidified prior to reaching the gas chamber 45 on the upper side, and is supplied via the hydrogen supply flow path 60 to the hydrogen compression stack 16.

In the return flow path 94, between the gas-liquid separator 18 and the first hydrogen storage tank 96, a pressure reducing valve 73, a flow amount adjusting valve 74, a check valve 97, and an opening/closing valve 98 are provided sequentially in this order from the upstream side. In response to a command from the control device 30, the pressure reducing valve 73 reduces the pressure of the high pressure hydrogen gas that is discharged from the gas-liquid separator 18. The hydrogen gas which has been reduced in pressure flows to the downstream side. By means of a command from the control device 30, the flow amount adjusting valve 74 adjusts the flow amount of the hydrogen gas which has been reduced in pressure by the pressure reducing valve 73. The check valve 97, together with causing the hydrogen gas to flow to the first hydrogen storage tank 96 from the gas-liquid separator 18, prevents the high pressure hydrogen gas from flowing back from the first hydrogen storage tank 96 to the gas-liquid separator 18. Moreover, at a time of normal operation, the flow amount adjusting valve 74 is closed, and the hydrogen gas does not flow downstream of the flow amount adjusting valve 74. The time of normal operation refers to an operating state in which, together with a predetermined amount of the hydrogen gas being continuously supplied to the hydrogen compression stack 16 from the hydrogen supply device 14, the electrical power source device 28 continues to apply a predetermined voltage to the hydrogen compression stack 16, and thereby is continuously generating the high pressure hydrogen gas, and does not include an operating state at a time of starting, a time of stoppage, or a time of being temporarily stopped.

In the return flow path 94, a waste flow path 82 is connected to a branch point 81 positioned between the flow amount adjusting valve 74 and the opening/closing valve 98. A waste valve 83, which is an opening/closing valve, is provided in the waste flow path 82. The waste valve 83, by being opened, releases the hydrogen gas to the exterior, and by being closed, stops releasing the hydrogen gas to the exterior. As the exterior, there may be considered, for example, any one of the atmosphere, underwater, or outer space. The check valve 97 is provided in the return flow path 94, so that when the waste valve 83 is opened, the hydrogen gas that is stored in the first hydrogen storage tank 96 is not released to the exterior.

At a time when the hydrogen gas is being supplied, via the return flow path 94, from the first hydrogen storage tank 96 to the sealed container 44, the raw material hydrogen is not supplied to the sealed container 44. More specifically, the opening/closing valve 52 that is provided in the raw material hydrogen supply path 50 is closed. Further, the pressure of the hydrogen gas that is stored in the first hydrogen storage tank 96 is higher than the pressure of the hydrogen gas contained in the sealed container 44. Accordingly, even if the raw material hydrogen is not supplied to the sealed container 44, the hydrogen gas can satisfactorily be supplied via the sealed container 44 from the first hydrogen storage tank 96 to the hydrogen compression stack 16. The pressure of the raw material hydrogen may be higher than the pressure of the hydrogen gas that is contained in the first hydrogen storage tank 96.

The control device 30 is constituted by an ECU (Electronic Control Unit). The ECU is composed of a computer having at least one processor (CPU), a memory, an input/output interface, and an electronic circuit. The at least one processor (CPU) executes a non-illustrated program (computer-executable instructions) that is stored in a memory. The control device 30 comprehensively carries out a control in relation to the electrochemical hydrogen compression system 10.

Concerning the operation of the electrochemical hydrogen compression system 10 at a time of normal operation, a description thereof will be given with reference to FIG. 1. The arrows shown in FIG. 1 indicate the flow direction of the hydrogen gas.

The control device 30 opens the opening/closing valve 52 provided in the raw material hydrogen supply path 50, and thereby supplies the raw material hydrogen to the hydrogen supply device 14. The amount of water in the raw material hydrogen that was supplied to the sealed container 44 of the hydrogen supply device 14 is adjusted by the liquid water, and the raw material hydrogen is supplied as a hydrogen gas, via the hydrogen outlet 46 and the hydrogen supply flow path 60, to the hydrogen inlet PT1 of the hydrogen compression stack 16. Unused hydrogen gas that is discharged from the hydrogen outlet PT2 of the hydrogen compression stack 16 is circulated, via the hydrogen circulation flow path 62, to the hydrogen circulation inlet 67 of the sealed container 44. The control device 30 controls the speed of rotation of the circulation pump 66 provided in the hydrogen circulation flow path 62, and thereby adjusts the flow amount of the circulating hydrogen gas.

The hydrogen gas that is supplied to the hydrogen compression stack 16 is electrochemically compressed by the voltage that is applied from the electrical power source device 28 to the hydrogen compression stack 16, and thereby becomes a high pressure hydrogen gas, and the high pressure hydrogen gas is output from the high pressure hydrogen outlet PT3 to the high pressure hydrogen supply flow path 70. The high pressure hydrogen gas that has been output, after the liquid water has been removed therefrom by the gas-liquid separator 18 provided in the high pressure hydrogen supply flow path 70, is supplied to the condenser 20. The high pressure hydrogen gas, which has been dehumidified in the condenser 20, is supplied to the water removal device 22. In addition, by having been further dehumidified in the water removal device 22, the dried high pressure hydrogen gas is supplied, via the high pressure hydrogen outlet flow path 122, to the hydrogen tank 25 or the like that is provided in the storage device 24.

The control device 30, by controlling the back pressure valve 124 provided in the high pressure hydrogen outlet flow path 122, adjusts the pressure of the high pressure hydrogen gas that is supplied to the hydrogen tank 25.

When the normal operation ends and the hydrogen compression stack 16 stops operating, the high pressure hydrogen gas remains in the flow path that communicates with the cathode 40 of the hydrogen compression stack 16. Further, the high pressure hydrogen gas also remains in the gas-liquid separator 18, the condenser 20, and the water removal device 22, which are provided downstream of the hydrogen compression stack 16, and in the high pressure hydrogen supply flow path 70 that connects these constituent elements together. The high pressure hydrogen gas that remains in those components is collectively referred to as “high pressure hydrogen gas remaining on the side of the cathode”.

When the hydrogen compression stack 16 stops operating, the high pressure hydrogen gas remaining on the side of the cathode is reduced in pressure at an appropriate speed. Such an operation is referred to as depressurization, and the process for carrying out the operation is referred to as a depressurization process. If the high pressure hydrogen gas remaining on the side of the cathode is suddenly reduced in pressure, the electrolyte membrane 34 of the hydrogen compression stack 16 will be damaged. Therefore, the speed of the pressure reduction is adjusted, to thereby suppress a sudden decrease in the pressure of the high pressure hydrogen gas.

In the first embodiment, in order to reduce the pressure of the high pressure hydrogen gas that remains on the side of the cathode, the high pressure hydrogen gas is supplied from the gas-liquid separator 18 provided in the high pressure hydrogen supply flow path 70, via the return flow path 94, to the first hydrogen storage tank 96. At this time, the pressure and the flow amount of the high pressure hydrogen gas are optimally adjusted respectively by the pressure reducing valve 73 and the flow amount adjusting valve 74 provided in the return flow path 94. In this manner, the electrolyte membrane 34 of the hydrogen compression stack 16 can be suppressed from being damaged. Any surplus hydrogen gas that cannot be stored in the first hydrogen storage tank 96 is discharged via the waste flow path 82 to the exterior.

When the hydrogen compression stack 16 starts operating, the hydrogen gas is returned, via the return flow path 94, from the first hydrogen storage tank 96 to the sealed container 44 of the hydrogen supply device 14. The downstream end of the return flow path 94 has an opening that opens into the liquid water contained in the sealed container 44. In accordance with this feature, the hydrogen gas turns into bubbles and rises upwardly through the liquid water in the sealed container 44, and is humidified by the liquid water.

The storage device 24 includes the pressure sensor P1 that measures the pressure of the high pressure hydrogen gas. The pressure of the hydrogen gas measured by the pressure sensor P1 corresponds to the amount of the high pressure hydrogen gas contained in the hydrogen tank 25. The hydrogen tank 25 has a maximum storage pressure (Pmax). This maximum storage pressure corresponds to a maximum amount of the hydrogen gas that is capable of being stored in the hydrogen tank 25.

In the case that the gas pressure of the hydrogen tank 25, which is measured by the pressure sensor P1, is a predetermined value (Ptmp) that is lower than the maximum storage pressure, the hydrogen tank 25 can be further filled with hydrogen gas at a pressure (a fillable gas pressure) corresponding to Pmax−Ptmp=Pemp. Accordingly, in the case that the depressurization is executed, in the case that the gas pressure of the hydrogen tank 25 is low and the fillable gas pressure is high, the high pressure hydrogen gas remaining on the side of the cathode may be supplied first to the hydrogen tank 25, and then to the first hydrogen storage tank 96.

In the first embodiment, the fillable gas pressure is calculated from the pressure of the hydrogen gas in the hydrogen tank 25 which is measured by the pressure sensor P1. In addition, in the case that the hydrogen gas obtained by subtracting this fillable gas pressure from the pressure of the high pressure hydrogen gas remaining on the side of the cathode is filled into the first hydrogen storage tank 96, the pressure of the hydrogen gas that is capable of being stored in the first hydrogen storage tank 96 is estimated. More specifically, at the time when the depressurization is carried out, based on the gas pressure measured by the pressure sensor P1 that is provided in the hydrogen tank 25, the pressure of the hydrogen gas that is capable of being stored in the first hydrogen storage tank 96 is estimated.

In this case, the volume of the hydrogen tank 25, the volume of the first hydrogen storage tank 96, and the volume of the flow paths in relation to the depressurization are acquired in advance and are stored as parameters. The pressure of the hydrogen gas that is capable of being stored in the first hydrogen storage tank 96 can be calculated from these volume parameters, and the hydrogen gas pressure measured by the pressure sensor P1 that is provided in the first hydrogen storage tank 96.

In addition, in the case that the estimated pressure of the hydrogen gas that is capable of being stored in the first hydrogen storage tank 96 is lower than the pressure of the hydrogen gas contained in the sealed container 44, the high pressure hydrogen gas is not supplied to the first hydrogen storage tank 96. This is because in the case that the estimated pressure of the hydrogen gas that is capable of being stored in the first hydrogen storage tank 96 is lower than the pressure of the hydrogen gas contained in the sealed container 44, the hydrogen gas cannot be satisfactorily supplied, via the hydrogen supply device 14, from the first hydrogen storage tank 96 to the hydrogen compression stack 16. The pressure of the hydrogen gas contained in the sealed container 44 is measured by the pressure sensor P3, or alternatively, may be set in advance as a minimum predetermined pressure value required in order to supply the hydrogen gas to the hydrogen compression stack 16.

### Flowchart According to First Embodiment

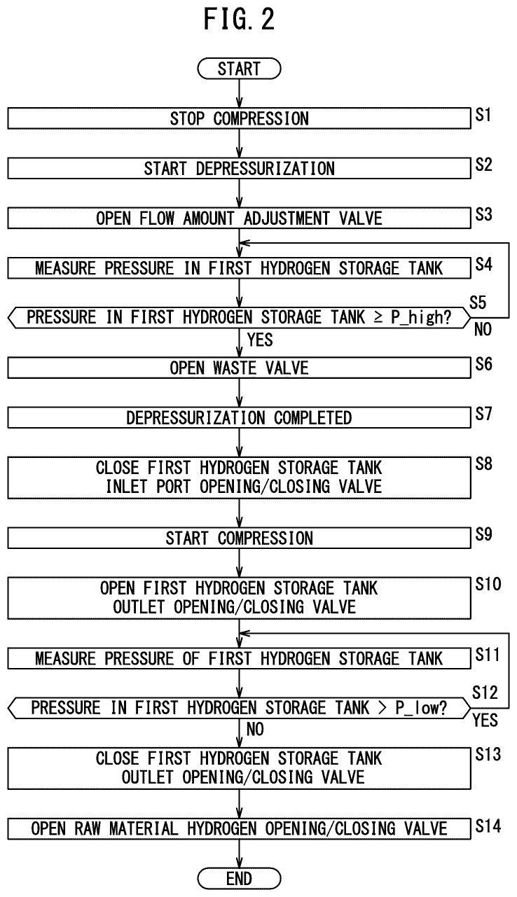

The operating procedure of the electrochemical hydrogen compression system 10 according to the first embodiment will be described based on the flow chart shown in FIG. 2.

At a time of normal operation, after the high pressure hydrogen gas that was electrochemically compressed in the hydrogen compression stack 16 has flowed through the gas-liquid separator 18, the condenser 20, and the water removal device 22 provided in the high pressure hydrogen supply flow path 70, the high pressure hydrogen gas is stored in the hydrogen tank 25. In step S1, the control device 30 instructs the hydrogen compression stack 16 to stop compression (to stop operation). Specifically, the control device 30 causes the electrical power source device 28 to stop applying the voltage to the hydrogen compression stack 16. In this case, the control device 30 may gradually cause the voltage to be reduced over time, and ultimately, may stop applying the voltage. At the same time, the control device 30 closes the opening/closing valve 52 and stops the supply of the raw material hydrogen. Accordingly, the supply of the hydrogen gas from the hydrogen supply device 14 to the hydrogen compression stack 16 is stopped.

In step S2, the control device 30 initiates a depressurization process in which the depressurization of the electrochemical hydrogen compression system 10 is executed.

In step S3, the control device 30 opens the flow amount adjusting valve 74, and supplies the hydrogen gas, which was reduced in pressure by the pressure reducing valve 73, to the first hydrogen storage tank 96. The flow amount adjusting valve 74 adjusts the flow amount per unit time of the flowing hydrogen gas, to such an extent that the hydrogen compression stack 16 does not incur damage. In this case, the opening/closing valve 98, which is provided upstream of the first hydrogen storage tank 96, is opened, and the opening/closing valve 95, which is provided downstream of the first hydrogen storage tank 96, is closed.

In step S4, the control device 30, by using the pressure sensor P2 provided in the first hydrogen storage tank 96, measures the pressure of the hydrogen gas in the first hydrogen storage tank 96. When the depressurization is started, and the high pressure hydrogen gas remaining on the side of the cathode of the hydrogen compression stack 16 begins to flow into the first hydrogen storage tank 96, the pressure of the hydrogen gas in the first hydrogen storage tank 96 rises over time.

In step S5, the control device 30 determines whether or not the pressure in the first hydrogen storage tank 96, which is measured by the pressure sensor P2, is higher than a first predetermined value (P_high). In addition, in the case that the determination result is positive (step S5: YES), the control device 30 proceeds to step S6. In the case that the determination result is negative (step S5: NO), the control device 30 returns to step S4. The first predetermined value is a pressure that is lower than the pressure of the hydrogen gas that is discharged from the hydrogen compression stack 16, and is higher than the pressure of the hydrogen gas contained in the sealed container 44.

In step S6, the control device 30 opens the waste valve 83 that is provided in the waste flow path 82. In addition, after the waste valve 83 has been left open for a predetermined time period, the waste valve 83 is closed. In accordance with this feature, the excess hydrogen gas remaining after having been stored in the first hydrogen storage tank 96 is released into the atmosphere. In this case, due to the check valve 97, the hydrogen gas that is stored in the first hydrogen storage tank 96 is not released to the exterior via the waste flow path 82.

In step S7, the control device 30 determines that the depressurization is completed. Moreover, in the first embodiment, although the depressurization is completed based on the pressure of the hydrogen gas that is stored in the first hydrogen storage tank 96, by measuring beforehand a relationship between the pressure of the high pressure hydrogen gas remaining on the side of the cathode when the depressurization is started, and a predetermined time period until the depressurization is completed, the completion of the depressurization may be determined based on such a predetermined time period.

In step S8, the control device 30 closes the opening/closing valve 98 that is provided upstream of the first hydrogen storage tank 96. In accordance therewith, the supply of the high pressure hydrogen gas to the first hydrogen storage tank 96 is stopped. Consequently, the depressurization process comes to an end.

After a predetermined time period has elapsed since the depressurization step was completed, in step S9, the control device 30 instructs the hydrogen compression stack 16 to start compression.

In step S10, the control device 30 opens the opening/closing valve 95 that is provided downstream of the first hydrogen storage tank 96. In accordance with this feature, the hydrogen gas is supplied from the first hydrogen storage tank 96 to the sealed container 44 of the hydrogen supply device 14. In addition, the hydrogen gas is humidified by the liquid water that is stored in the sealed container 44, and is supplied to the hydrogen compression stack 16.

In step S11, the control device 30, by using the pressure sensor P2 provided in the first hydrogen storage tank 96, measures the pressure of the hydrogen gas in the first hydrogen storage tank 96. As the hydrogen gas that is stored in the first hydrogen storage tank 96 is supplied to the sealed container 44, the measured pressure of the hydrogen gas decreases.

In step S12, the control device 30 determines whether or not the pressure in the first hydrogen storage tank 96, which is measured by the pressure sensor P2, exceeds a second predetermined value (P_low). In addition, in the case that the determination result is positive (step S12: YES), the control device 30 returns to step S11. In the case that the determination result is negative (step S12: NO), the control device 30 proceeds to step S13. The second predetermined value (P_low) is a pressure that is higher than the pressure of the hydrogen gas contained in the sealed container 44. This is because, in the case that the pressure of the hydrogen gas supplied from the first hydrogen storage tank 96 to the sealed container 44 is lower than the pressure of the hydrogen gas contained in the sealed container 44, the hydrogen gas will not be satisfactorily supplied to the hydrogen compression stack 16. The pressure of the hydrogen gas contained in the sealed container 44 is measured by the pressure sensor P3, or alternatively, may be set in advance as a minimum predetermined pressure value required in order to supply the hydrogen gas to the hydrogen compression stack 16. Moreover, the second predetermined value is a pressure that is lower than the first predetermined value.

In step S13, the control device 30 closes the opening/closing valve 95 that is provided downstream of the first hydrogen storage tank 96. In accordance with this feature, the supply of the hydrogen gas from the first hydrogen storage tank 96 to the sealed container 44 is stopped.

In step S14, the control device 30 opens the opening/closing valve 52 that is provided in the raw material hydrogen supply path 50. In accordance with this feature, the raw material hydrogen is supplied to the sealed container 44. In addition, the raw material hydrogen is humidified by the liquid water that is stored in the sealed container 44, and is supplied as hydrogen gas to the hydrogen compression stack 16.

### Timing Chart According to First Embodiment

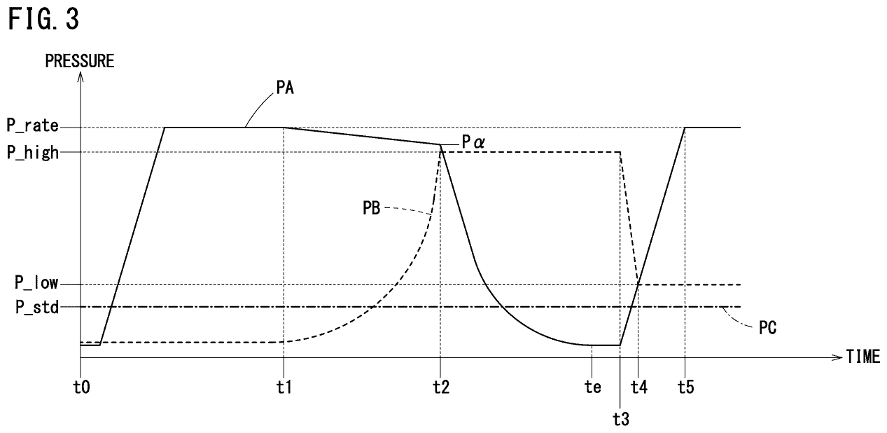

A timing chart according to the first embodiment will be described with reference to FIG. 3. In such a timing chart, the flow chart which is described in FIG. 2 is described on a time axis.

In this timing chart, there are shown changes over time in a pressure (PA) of the high pressure hydrogen gas at the high pressure hydrogen outlet PT3 of the hydrogen compression stack 16, a pressure (PB) of the hydrogen gas detected by the pressure sensor P2 provided in the first hydrogen storage tank 96, and a pressure (PC) of the hydrogen gas in the gas chamber 45 of the sealed container 44 that is measured by the pressure sensor P3 and supplied to the hydrogen compression stack 16.

At time t0, a voltage is applied from the electrical power source device 28 to the hydrogen compression stack 16, and the hydrogen gas is supplied at a predetermined pressure (P_std=PC) to the hydrogen compression stack 16. In accordance with this feature, the operation of the hydrogen compression stack 16 is started. In addition, the pressure (PA) of the high pressure hydrogen gas discharged from the high pressure hydrogen outlet PT3 gradually increases, and reaches the rated pressure (P_rate). Moreover, in a state in which the hydrogen compression stack 16 continues to operate, the control device 30 controls the electrical power source device 28, and thereby maintains the pressure (PA) that the hydrogen compression stack 16 discharges from the high pressure hydrogen outlet PT3 at a constant value, namely, the rated pressure (P_rate).

At time t1, the control device 30 causes the application of the voltage from the electrical power source device 28 to the hydrogen compression stack 16 to be stopped, and thereby stops the operation of the hydrogen compression stack 16 (step S1), and the depressurization process of the high pressure hydrogen gas on the side of the cathode is started (step S2). Specifically, the depressurization is carried out by supplying, via the return flow path 94, the high pressure hydrogen gas on the side of the cathode to the first hydrogen storage tank 96. Along with the depressurization from time t1, the pressure (PA) of the high pressure hydrogen gas decreases from the rated pressure (P_rate), and the pressure (PB) of the first hydrogen storage tank 96 rises.

At time t2, the pressure (PB) of the hydrogen gas in the first hydrogen storage tank 96 reaches the first predetermined value (P_high) (step S4, step S5: YES). At this time t2, the pressure (PA) of the high pressure hydrogen gas on the side of the cathode decreases to a pressure (Pα) between the rated pressure (P_rate) and the first predetermined value (P_high). Thereafter, by the waste valve 83 being opened for a predetermined time period, the pressure (PA) of the high pressure hydrogen gas further decreases from the pressure (Pα), and becomes equal to the external pressure. After time t2, the pressure (PB) of the hydrogen gas in the first hydrogen storage tank 96 is maintained at the first predetermined value (P_high), which is a constant pressure (step S6). In this manner, the depressurization is completed at time te (step S7), and at the depressurization completion time te, the control device 30 closes the opening/closing valve 98 that is provided upstream of the first hydrogen storage tank 96 (step S8).

Thereafter, at time t3, in order to initiate the compression operation of the hydrogen compression stack 16, the control device 30 opens the opening/closing valve 95 that is provided on the downstream side of the first hydrogen storage tank 96. In this manner, the hydrogen gas is supplied from the first hydrogen storage tank 96, via the hydrogen supply device 14, to the hydrogen compression stack 16, and the compression operation of the hydrogen compression stack 16 is started (step S9, step S10). After time t3, together with the pressure (PA) of the high pressure hydrogen gas discharged from the high pressure hydrogen outlet PT3 gradually rising, the pressure (PB) of the first hydrogen storage tank 96 gradually decreases.

From time t3, the amount of the hydrogen gas that is stored in the first hydrogen storage tank 96 is reduced, and at time t4, the hydrogen gas pressure (PB) decreases to the second predetermined value (P_low) (step S11, step S12: NO). At this time t4, the control device 30, together with closing the opening/closing valve 95 that is provided downstream of the first hydrogen storage tank 96 (step S13), opens the opening/closing valve 52 that is provided in the raw material hydrogen supply path 50. In accordance with this feature, the supply of the hydrogen gas from the first hydrogen storage tank 96 is stopped, and by the raw material hydrogen gas being supplied, via the raw material hydrogen supply path 50, to the sealed container 44, after time t4, the pressure (PA) of the high pressure hydrogen gas output from the high pressure hydrogen outlet PT3 continues to rise.

After time t4 as well, the pressure (PA) of the high pressure hydrogen gas output from the high pressure hydrogen outlet PT3 gradually rises, and at time t5, again reaches the rated pressure (P_rate). Subsequently, the timing chart is repetitive, and therefore, description thereof will be omitted.

### Second Embodiment

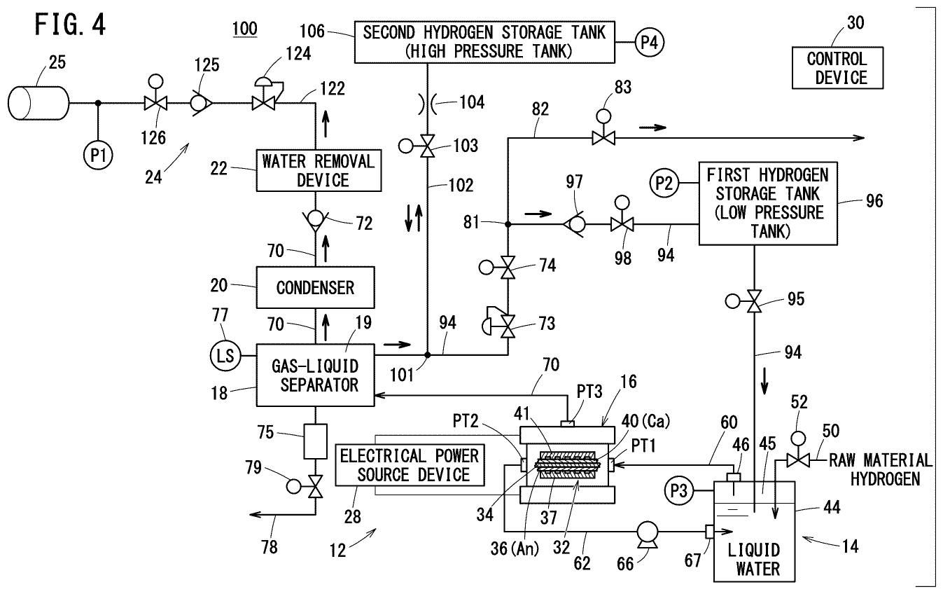

FIG. 4 is a schematic diagram showing an electrochemical hydrogen compression system 100 according to a second embodiment. In FIG. 4, the same constituent elements as those described in the first embodiment are designated by the same reference numerals. Moreover, it should be noted that in the second embodiment, descriptions that overlap or are redundant with those in the first embodiment will be omitted.

As shown in FIG. 4, the electrochemical hydrogen compression system 100 includes a first hydrogen storage tank (hydrogen storage tank) 96, and a second hydrogen storage tank (hydrogen storage tank) 106. The second hydrogen storage tank 106 is disposed in parallel with the first hydrogen storage tank 96 with respect to the return flow path 94. The pressure of the hydrogen gas that is stored in the second hydrogen storage tank 106 is higher than the pressure of the hydrogen gas that is stored in the first hydrogen storage tank 96. More specifically, the first hydrogen storage tank 96 is a low pressure tank, and the second hydrogen storage tank 106 is a high pressure tank. The number of hydrogen storage tanks (96, 106) that are installed in parallel with respect to the return flow path 94 should be at least two, and may be three or more. In this case, the pressures of the hydrogen gases that are stored in each of the hydrogen storage tanks (96, 106) differ from each other.

A branch point 101 is provided in the return flow path 94 between the gas-liquid separator 18 and the pressure reducing valve 73. A connecting flow path 102 is connected to the branch point 101. In addition, the second hydrogen storage tank 106 communicates, via the connecting flow path 102 and the branch point 101, with the return flow path 94. The second hydrogen storage tank 106 includes a gas flow opening. The high pressure hydrogen gas flows, via this gas flow opening, into the second hydrogen storage tank 106 and out of the second hydrogen storage tank 106.

An opening/closing valve 103 and a flow amount adjusting valve 104 are provided in the connecting flow path 102 that extends from the branch point 101 toward the second hydrogen storage tank 106. The opening/closing valve 103, by being opened, allows the high pressure hydrogen gas to flow, and by being closed, stops the flow of the high pressure hydrogen gas. The control device 30 adjusts the flow amount of the hydrogen gas that flows through the flow amount adjusting valve 104. When the operation of the hydrogen compression stack 16 is stopped, if the high pressure hydrogen gas remaining on the side of the cathode is suddenly decompressed, since the electrolyte membrane 34 of the hydrogen compression stack 16 will incur damage, the speed of the depressurization is adjusted by the flow amount adjusting valve 104, to thereby suppress a sudden reduction in the pressure of the high pressure hydrogen gas. Moreover, at a time of normal operation, the opening/closing valve 103 is closed, and the flow of the high pressure hydrogen gas between the return flow path 94 and the second hydrogen storage tank 106 is stopped. A pressure sensor P4 that measures the pressure of the stored hydrogen gas is provided in the second hydrogen storage tank 106. The pressure sensor P4 may be disposed in a pipe connected to a gas flow opening provided in the second hydrogen storage tank 106.

### Flowchart According to Second Embodiment

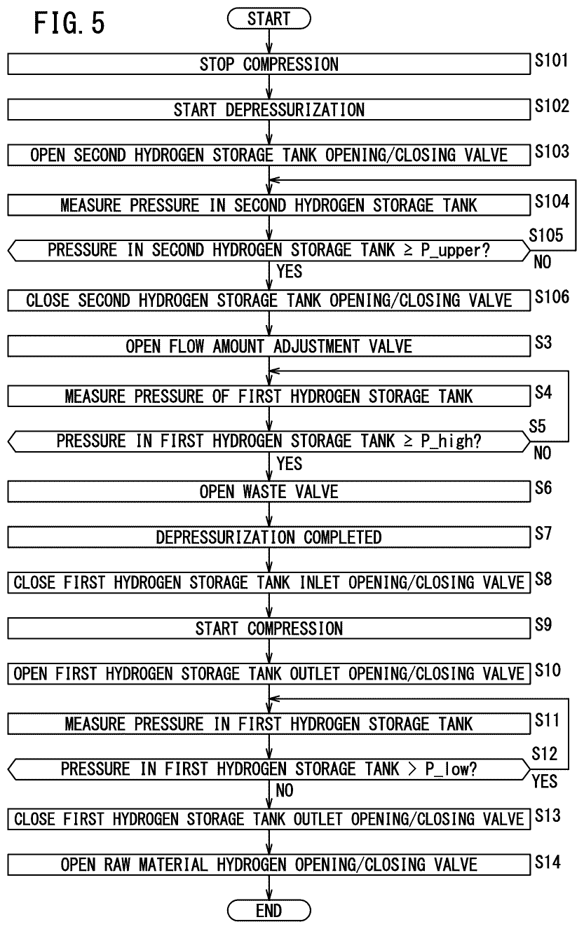

The operating procedure of the electrochemical hydrogen compression system 100 according to the second embodiment will be described based on the flow chart shown in FIG. 5. In the description of FIG. 5, the same steps as those described in the first embodiment are designated by the same reference numerals. Moreover, it should be noted that in the second embodiment, descriptions that overlap or are redundant with those in the first embodiment will be omitted.

At a time of normal operation, after the high pressure hydrogen gas that was compressed in the hydrogen compression stack 16 has flowed through the gas-liquid separator 18, the condenser 20, and the water removal device 22 provided in the high pressure hydrogen supply flow path 70, the high pressure hydrogen gas is stored in the hydrogen tank 25. In step S101, the control device 30 instructs the hydrogen compression stack 16 to stop compression (to stop operation). Specifically, the control device 30 causes the electrical power source device 28 to stop applying the voltage to the hydrogen compression stack 16. In this case, the control device 30 may gradually cause the voltage to be reduced over time, and ultimately, may stop applying the voltage. At the same time, the control device 30 closes the opening/closing valve 52 and stops the supply of the hydrogen gas from the hydrogen supply device 14 to the hydrogen compression stack 16.

In step S102, the control device 30 initiates a depressurization process in which the depressurization of the electrochemical hydrogen compression system 100 is executed.

In step S103, the control device 30 opens the opening/closing valve 103, and thereby supplies the high pressure hydrogen gas to the second hydrogen storage tank 106. The flow amount adjusting valve 104 adjusts the flow amount per unit time of the hydrogen gas flowing through the hydrogen compression stack 16, to such an extent that the hydrogen compression stack 16 does not incur damage. In this case, the opening/closing valve 98, which is provided upstream of the first hydrogen storage tank 96, is closed, and the opening/closing valve 95, which is provided downstream of the first hydrogen storage tank 96, is also closed. Accordingly, the hydrogen gas is not supplied to the first hydrogen storage tank 96.

In step S104, the control device 30, by using the pressure sensor P4 provided in the second hydrogen storage tank 106, measures the pressure of the hydrogen gas in the second hydrogen storage tank 106. When the depressurization is started, and the high pressure hydrogen gas remaining on the side of the cathode of the hydrogen compression stack 16 begins to flow into the second hydrogen storage tank 106, the pressure of the hydrogen gas in the second hydrogen storage tank 106 rises over time.

In step S105, the control device 30 determines whether or not the pressure of the second hydrogen storage tank 106, which is measured by the pressure sensor P4, is higher than a third predetermined value (P_upper). In addition, in the case that the determination result is positive (step S105: YES), the control device 30 proceeds to step S106. In the case that the determination result is negative (step S105: NO), the control device 30 returns to step S104.

In step S106, the control device 30 closes the opening/closing valve 103. In accordance therewith, the supply of the high pressure hydrogen gas to the second hydrogen storage tank 106 is stopped. In addition, a state is maintained in which the hydrogen gas is filled in the interior of the second hydrogen storage tank 106 at the third predetermined value (P_upper). Moreover, in the second embodiment, although the opening/closing valve 103 is closed based on the pressure of the hydrogen gas that is stored in the second hydrogen storage tank 106, by measuring beforehand a relationship between the pressure of the high pressure hydrogen gas remaining on the side of the cathode when the depressurization is started, and a predetermined time period until depressurization is completed, the opening/closing valve 103 may be closed based on such a predetermined time period.

Following step S106, the other steps, i.e., step S3 to step S14, are similar to those described in the first embodiment, and therefore, description of these steps will be omitted.

### Timing Chart According to Second Embodiment

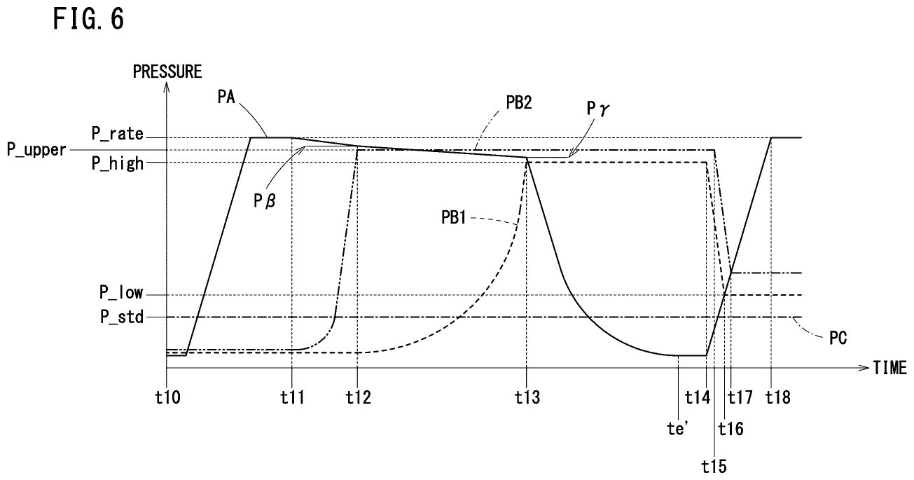

A timing chart according to the second embodiment will be described with reference to FIG. 6. In such a timing chart, the flow chart which is described in FIG. 5 is described on a time axis.

In this timing chart, there are shown changes over time in a pressure (PA) of the high pressure hydrogen gas at the high pressure hydrogen outlet PT3 of the hydrogen compression stack 16, a pressure (PB1) (PB1=PB) of the hydrogen gas measured by the pressure sensor P2 provided in the first hydrogen storage tank 96, a pressure (PB2) of the hydrogen gas detected by the pressure sensor P4 of the second hydrogen storage tank 106, and a pressure (PC) of the hydrogen gas in the gas chamber 45 of the sealed container 44 that is measured by the pressure sensor P3 and supplied to the hydrogen compression stack 16.

At time t10, a voltage is applied from the electrical power source device 28 to the hydrogen compression stack 16, and the hydrogen gas is supplied at a predetermined pressure (P_std=PC) to the hydrogen compression stack 16. In accordance with this feature, the operation of the hydrogen compression stack 16 is started. In addition, the pressure (PA) of the high pressure hydrogen gas output from the high pressure hydrogen outlet PT3 gradually increases, and reaches the rated pressure (P_rate). Moreover, in a state in which the hydrogen compression stack 16 continues to operate, the control device 30 controls the electrical power source device 28, and thereby maintains the pressure (PA) that the hydrogen compression stack 16 discharges from the high pressure hydrogen outlet PT3 at a constant value, namely, the rated pressure (P_rate).

At time t11, the control device 30 causes the application of the voltage from the electrical power source device 28 to the hydrogen compression stack 16 to be stopped, and thereby stops the operation of the hydrogen compression stack 16 (step S101), and the depressurization process of the high pressure hydrogen gas on the side of the cathode is started (step S102). Specifically, the depressurization is carried out by supplying, via the return flow path 94 and the connecting flow path 102, the high pressure hydrogen gas on the side of the cathode to the second hydrogen storage tank 106. Along with the depressurization from time t11, the pressure (PA) of the high pressure hydrogen gas decreases from the rated pressure (P_rate), and the pressure (PB2) in the second hydrogen storage tank 106 rises.

At time t12, the pressure (PB2) in the hydrogen gas that is stored in the second hydrogen storage tank 106 reaches the third predetermined value (P_upper) (step S104, step S105: YES). At this time t12, the pressure (PA) of the high pressure hydrogen gas on the side of the cathode decreases to a pressure (PB) between the rated pressure (P_rate) and the third predetermined value (P_upper). After time t12, by closing the opening/closing valve 103 provided in the connecting flow path 102, the pressure (PB2) of the hydrogen gas in the second hydrogen storage tank 106 is maintained at the third predetermined value (P_upper), which is a constant pressure.

Further, at time t12, the high pressure hydrogen gas of the pressure (PA) flows through the pressure reducing valve 73, the flow amount adjusting valve 74, and the opening/closing valve 98 that is in the open state, and is introduced into the first hydrogen storage tank 96 (step S3). In accordance with this feature, together with the pressure (PA) of the high pressure hydrogen gas further decreasing from time t12, the pressure (PB1) of the hydrogen gas that is stored in the first hydrogen storage tank 96 rises.

At time t13, the pressure (PB1) of the hydrogen gas in the first hydrogen storage tank 96 reaches the first predetermined value (P_high) (step S4, step S5: YES). Further, at time t13, the pressure (PA) of the high pressure hydrogen gas on the side of the cathode decreases to a pressure (Pγ) between the third predetermined value (P_upper) and the first predetermined value (P_high). The first predetermined value (P_high) is a pressure that is lower than the third predetermined value (P_upper).

After time t13, the control device 30 opens the waste valve 83 for a predetermined time period which, together with causing the pressure (PA) of the high pressure hydrogen gas to further decrease from the pressure (Pγ) and become equivalent to the external pressure, maintains the pressure (PB1) of the hydrogen gas in the first hydrogen storage tank 96 at the first predetermined value (P_high) which is a constant value (step S6). At the time te′ when the pressure of the high-pressure hydrogen gas (PA) has become equivalent to the external pressure, depressurization is completed (step S7). At the depressurization completion time te′, the control device 30 closes the opening/closing valve 98 that is provided upstream of the first hydrogen storage tank 96 (step S8).

Thereafter, at time t14, in order to initiate the compression operation of the hydrogen compression stack 16, the control device 30 opens the opening/closing valve 95 that is provided on the downstream side of the first hydrogen storage tank 96. In this manner, the hydrogen gas is supplied from the first hydrogen storage tank 96, via the hydrogen supply device 14, to the hydrogen compression stack 16, and the compression operation of the hydrogen compression stack 16 is started (step S9, step S10). After time t14, together with the pressure (PA) of the high pressure hydrogen gas discharged from the high pressure hydrogen outlet PT3 gradually rising, the pressure (PB1) of the first hydrogen storage tank 96 gradually decreases.

Further, at time t15, the control device 30 opens the opening/closing valve 103 that is provided in the connecting flow path 102. The high pressure hydrogen gas that is stored in the second hydrogen storage tank 106 is supplied, via the gas-liquid separator 18, to the side of the cathode of the hydrogen compression stack 16. In accordance therewith, the pressure (PA) of the high pressure hydrogen gas on the side of the cathode of the hydrogen compression stack 16 increases rapidly. Moreover, the high pressure hydrogen gas that is stored in the second hydrogen storage tank 106 may be supplied, not via the gas-liquid separator 18, but directly to the side of the cathode of the hydrogen compression stack 16.

At time t16, the pressure (PB1) of the first hydrogen storage tank 96 decreases to the second predetermined value (P_low) (step S11, step S12: NO). At this time t17, the control device 30, together with closing the opening/closing valve 95 that is provided downstream of the first hydrogen storage tank 96 (step S13), opens the opening/closing valve 52 that is provided in the raw material hydrogen supply path 50. After time t17, the supply of the hydrogen gas from the first hydrogen storage tank 96 is stopped, and the raw material hydrogen, which is a hydrogen gas, is supplied, via the raw material hydrogen supply path 50, to the sealed container 44.

At time t17, the pressure (PB2) of the high pressure hydrogen gas in the second hydrogen storage tank 106 becomes the same as the pressure (PA) of the high pressure hydrogen gas output from the high pressure hydrogen outlet PT3 of the hydrogen compression stack 16. Thus, at time t17, the control device 30 closes the opening/closing valve 103 that is provided in the connecting flow path 102. In accordance with this feature, the supply of the hydrogen gas from the second hydrogen storage tank 106 is stopped.

After time t17 as well, the pressure (PA) of the high pressure hydrogen gas discharged from the high pressure hydrogen outlet PT3 gradually rises, and at time t18, again reaches the rated pressure (P_rate). Subsequently, the timing chart is repetitive, and therefore, description thereof will be omitted.

In relation to the above-described embodiment, the following supplementary notes are further disclosed.

### Supplementary Note 1

The electrochemical hydrogen compression system 10, 100 of the present disclosure comprises the hydrogen compression stack 16 having the unit cell 32 including the electrolyte membrane 34, the anode 36 disposed on the one surface of the electrolyte membrane 34, and the cathode 40 disposed on the other surface of the electrolyte membrane 34, and that supplies the hydrogen gas to the anode 36, and delivers from the cathode 40 the hydrogen gas which has been compressed, the electrical power source device 28 that applies the voltage to the hydrogen compression stack 16, the hydrogen supply device 14 that supplies the hydrogen gas to the hydrogen compression stack 16, the storage device 24 that stores the hydrogen gas output from the hydrogen compression stack 16, and the return flow path 94 that returns the hydrogen gas output from the hydrogen compression stack 16 to the hydrogen supply device 14, wherein the hydrogen storage tank 96, 106 that stores the hydrogen gas is provided in the return flow path 94.

In accordance with this feature, at the time when the hydrogen compression stack stops operating and is depressurized, the hydrogen gas remaining on the side of the cathode of the hydrogen compression stack can be stored via the return flow path in the hydrogen storage tank. In addition, when the operation is started, by the hydrogen gas that is stored in the hydrogen storage tank being supplied to the hydrogen compression stack, since the hydrogen gas can be circulated and reused within the electrochemical hydrogen compression system, the amount of the hydrogen gas that is released to the exterior is reduced. Accordingly, the efficiency with which the hydrogen gas is used is heightened, and a decrease in the hydrogen production efficiency of the electrochemical hydrogen compression system can be suppressed. Further, since the amount of the hydrogen gas discharged to the exterior is reduced, the configuration of the electrochemical hydrogen compression system associated with the discharge of the hydrogen gas becomes simplified, and is economical.

### Supplementary Note 2

In the electrochemical hydrogen compression system 10, 100 according to Supplementary Note 1, the hydrogen supply device may include the sealed container 44 that contains the hydrogen gas, and the pressure of the hydrogen gas that is stored in the hydrogen storage tank may be higher than the pressure of the hydrogen gas contained in the sealed container.

In accordance with this feature, the hydrogen gas that is stored in the hydrogen storage tank can be satisfactorily supplied to the hydrogen compression stack instead of the raw material hydrogen.

### Supplementary Note 3

In the electrochemical hydrogen compression system 10, 100 according to Supplementary Note 2, when the hydrogen gas is supplied from the hydrogen storage tank to the hydrogen supply device, the hydrogen storage tank may continue to supply the hydrogen gas to the hydrogen supply device until the pressure of the stored hydrogen gas decreases to a predetermined value.

In accordance with this feature, a large portion of the hydrogen gas stored in the hydrogen storage tank can be effectively utilized, thereby improving the hydrogen production efficiency. Further, since the amount of the hydrogen gas that is stored in the hydrogen storage tank is reduced, the hydrogen gas remaining on the side of the cathode of the hydrogen compression stack can be introduced.

### Supplementary Note 4

In the electrochemical hydrogen compression system 10, 100 according to Supplementary Note 3, the raw material hydrogen may be supplied to the hydrogen supply device via the raw material hydrogen supply path 50, and the opening/closing valve 52 may be provided in the raw material hydrogen supply path, and at the time when the hydrogen gas is being supplied from the hydrogen storage tank to the hydrogen supply device, the opening/closing valve may be closed and thereby stop the supply of the raw material hydrogen to the hydrogen supply device.

In accordance with this feature, it is possible to reduce the amount of the raw material hydrogen supplied to the hydrogen compression stack, thereby improving the hydrogen production efficiency.

### Supplementary Note 5

In the electrochemical hydrogen compression system 10, 100 according to Supplementary Note 1, the storage device may include the hydrogen tank 25 that stores the hydrogen gas, the pressure sensor P1 that measures the pressure of the stored hydrogen gas may be provided in the hydrogen tank, and at the time when depressurization is executed while the hydrogen compression stack is being stopped, the control device 30 may estimate the pressure of the hydrogen gas that is capable of being stored in the hydrogen storage tank based on the pressure of the hydrogen gas detected by the pressure sensor P1.

In accordance with this feature, it is possible to acquire the pressure of the hydrogen gas that is capable of being stored in the hydrogen storage tank, and it is possible to effectively utilize without waste the hydrogen gas remaining on the side of the cathode. Accordingly, the hydrogen production efficiency is improved.

### Supplementary Note 6

In the electrochemical hydrogen compression system 10, 100 according to Supplementary Note 5, the hydrogen supply device may include the sealed container 44 that contains the hydrogen gas, and in the case that the pressure of the hydrogen gas that is estimated to be capable of being stored in the hydrogen storage tank is lower than the pressure of the hydrogen gas contained in the sealed container, the hydrogen gas need not necessarily be supplied from the hydrogen compression stack to the hydrogen storage tank.

In accordance with this feature, when the depressurization is executed, without being circulated to the hydrogen compression stack, since the hydrogen gas remaining on the side of the cathode can be stored directly in the hydrogen tank, it is possible to efficiently utilize the high pressure hydrogen gas that has been compressed.

### Supplementary Note 7

In the electrochemical hydrogen compression system 100 according to Supplementary Note 1, the hydrogen storage tank may include the first hydrogen storage tank 96 and the second hydrogen storage tank 106 disposed in parallel with respect to the return flow path, and the pressure of the hydrogen gas that is stored in the second hydrogen storage tank may be higher than the pressure of the hydrogen gas that is stored in the first hydrogen storage tank.

In accordance with this feature, since the hydrogen gas can be stored in at least two hydrogen storage tanks having different pressures, the speed of the reduction in pressure can be set in stages at the time when the depressurization is executed, and thus it is possible to set an optimal speed of the reduction in pressure.

### Supplementary Note 8

In the electrochemical hydrogen compression system 100 according to Supplementary Note 7, when the depressurization of the hydrogen compression stack is executed, at the time when the pressure of the hydrogen gas stored in the second hydrogen storage tank exceeds the predetermined value, the supply of the hydrogen gas to the first hydrogen storage tank may be started.

In accordance with this feature, at the time when the depressurization is executed, since the hydrogen gas can be stored sequentially in at least two of the hydrogen storage tanks, an optimal amount and an optimal pressure of the hydrogen gas can be stored respectively in each of the hydrogen storage tanks.

### Supplementary Note 9

In the electrochemical hydrogen compression system 10, 100 according to Supplementary Note 8, at the time when the pressure of the hydrogen gas stored in the first hydrogen storage tank has exceeded the predetermined value, the waste valve 83 provided in the waste flow path 82 that is branched off from the return flow path may be opened, and the hydrogen gas remaining in the return flow path may be released to the exterior.

In accordance with this feature, it is possible to further reduce the pressure of the hydrogen gas that remains on the side of the cathode, and to satisfactorily suppress the electrolyte membrane from being damaged by the remaining hydrogen gas.

### Supplementary Note 10

In the electrochemical hydrogen compression system 100 according to Supplementary Note 7, at the time when the hydrogen compression stack starts operating, the hydrogen gas may be supplied from the second hydrogen storage tank to the cathode of the hydrogen compression stack.

In accordance with this feature, since the gas pressure on the side of the cathode of the hydrogen compression stack rises, the starting of the hydrogen compression stack can be accelerated, and the operation of the hydrogen compression stack can be quickly started.

Although the present disclosure has been described in detail, the present disclosure is not necessarily limited to each of the aforementioned embodiments. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of each of the operations and the order of each of the processes are illustrated as examples, and the present invention is not necessarily limited to these features.

1. An electrochemical hydrogen compression system, comprising:
a hydrogen compression stack having a unit cell including an electrolyte membrane, an anode disposed on one surface of the electrolyte membrane, and a cathode disposed on another surface of the electrolyte membrane, and configured to supply a hydrogen gas to the anode, and to deliver from the cathode a hydrogen gas which has been compressed;
an electrical power source device configured to apply a voltage to the hydrogen compression stack;
a hydrogen supply device configured to supply the hydrogen gas to the hydrogen compression stack;
a storage device configured to store the hydrogen gas output from the hydrogen compression stack; and
a return flow path configured to return the hydrogen gas output from the hydrogen compression stack to the hydrogen supply device;
wherein a hydrogen storage tank configured to store the hydrogen gas is provided in the return flow path.

2. The electrochemical hydrogen compression system according to claim 1, wherein the hydrogen supply device includes a sealed container configured to contain the hydrogen gas, and a pressure of the hydrogen gas that is stored in the hydrogen storage tank is higher than a pressure of the hydrogen gas contained in the sealed container.

3. The electrochemical hydrogen compression system according to claim 2, wherein in a case that the hydrogen gas is supplied from the hydrogen storage tank to the hydrogen supply device, the hydrogen storage tank continues to supply the hydrogen gas to the hydrogen supply device until the pressure of the hydrogen gas stored in the hydrogen storage tank decreases to a predetermined value.

4. The electrochemical hydrogen compression system according to claim 3, wherein:
raw material hydrogen is supplied to the hydrogen supply device via a raw material hydrogen supply path; and
an opening/closing valve is provided in the raw material hydrogen supply path, and at a time when the hydrogen gas is being supplied from the hydrogen storage tank to the hydrogen supply device, the opening/closing valve is closed, and the supply of the raw material hydrogen to the hydrogen supply device is stopped.

5. The electrochemical hydrogen compression system according to claim 1, wherein the storage device includes a hydrogen tank configured to store the hydrogen gas, a pressure sensor configured to measure a pressure of the hydrogen gas stored in the hydrogen tank is provided in the hydrogen tank, and a time when depressurization is executed while the hydrogen compression stack is being stopped, a control device estimates a pressure of the hydrogen gas that is capable of being stored in the hydrogen storage tank based on the pressure of the hydrogen gas detected by the pressure sensor.

6. The electrochemical hydrogen compression system according to claim 5, wherein:
the hydrogen supply device includes a sealed container configured to contain the hydrogen gas; and
in a case that the pressure of the hydrogen gas that is estimated to be capable of being stored in the hydrogen storage tank is lower than the pressure of the hydrogen gas contained in the sealed container, the hydrogen gas is not supplied to the hydrogen storage tank from the hydrogen compression stack.

7. The electrochemical hydrogen compression system according to claim 1, wherein the hydrogen storage tank includes a first hydrogen storage tank and a second hydrogen storage tank disposed in parallel with respect to the return flow path, and a pressure of the hydrogen gas that is stored in the second hydrogen storage tank is higher than a pressure of the hydrogen gas that is stored in the first hydrogen storage tank.

8. The electrochemical hydrogen compression system according to claim 7, wherein while depressurization of the hydrogen compression stack is executed, at a time when a pressure of the hydrogen gas stored in the second hydrogen storage tank exceeds a predetermined value, supply of the hydrogen gas to the first hydrogen storage tank is started.

9. The electrochemical hydrogen compression system according to claim 8, wherein, at a time when a pressure of the hydrogen gas stored in the first hydrogen storage tank exceeds below a predetermined value, a waste valve provided in a waste flow path branched off from the return flow path is opened, and the hydrogen gas remaining in the return flow path is released to an exterior.

10. The electrochemical hydrogen compression system according to claim 7, wherein at a time when the hydrogen compression stack starts operating, the hydrogen gas is supplied from the second hydrogen storage tank to the cathode of the hydrogen compression stack.
